SEQUENCE LISTING (5 sequences)

SEQ ID NO: 1 - protein, 720 aa, Yarrowia lipolytica
AFPSSIQKALAIPANNKTGTIQDVEHVIILMQENRSFDHYFGTLKGVRGFADRFTIPLPSGRRVWEQLRSNGQALTPFHLDGTANNAQRADGTPHTWNDSQLAWDNGRMANWPAHKTDISMGYFKEKEIPYQFALANAFTICDAYHCSMHTGTDANRSYHLTGTNGATPTKRSFVNNEWDWIDGNPATADRGYTWKTYAERLEEAGVNWICYQNMPDEWGDNMLGAFRSFRKANIASAYPVASGGEPNKPYADTGQKLPYKAYDAATDNAKNPLYKGIANTLPGNKPEEYLDAFKRDIREGKLPQVSWINAPSIYCEHPDPSSPVQGAWFIQEIIDALTAVPEVWSKTALIINFDENDGYFDHVPSPSAPSRLKNGQYAGKSTLSSADMQDEYFDHAAPEGSHSQPTPDGRVYGPGPRVPLYVISPWSRGGWVNSQVFDHTSVLMFLEKRFGIKEPNISPYRRAVCGDLTSAFNFKTPNADVLPQLNGKQTRLQADELRENQEALPAVPVPTDSKLPIQQSGIRLSRALPYELHTSARCKADGKVQLIFSNTGQQAAVFHVYDKLNLDRIPKRYIVEPNKTLDDEWDALKDNLGRYDLWVLGPNGYHRHFKGDTQRIVDSGIKPEIRVCYDIANGDVYVELMNDGTKDAILTVKPCAYRQDAPLQLAVKAGQVVKQHWALADIGHWYDFEITCQSDVSYYRRFAGRVETGEDSFSDPAMI

SEQ ID NO: 2 - protein, 265 aa, Bacillus subtilis
MAERSAPIGVMDSGVGGLSVLAEIQRLLPNETLLYVGDCGHIPYGEKSPDYIRERCRRIAGFFHEQGAKAMVLACNTATVAAVADLRELYPTWPLVGMEPAVKPAAAATRSGVVGVLATTGTLQSAKFAALLDRFANDVQVITQPCPGLVELIEAGDLVSPAVRQLLQGYVQPLLAAGCDTLILGCTHYPFLRPLLAGMVPDDVAIIDTGAAVARQLQRLLGANDLLAEGPAGAARFWTSADPEALRKILPVLWHKSDDVQSFAL

SEQ ID NO: 3 - protein, 409 aa, Bacillus subtilis
MPFRRTLLAASLALLITGQAPLYAAPPLSMDNGTNTLTVQNSNAWVEVSASALQHNIRTLQAELAGKSKLCAVLKADAYGHGIGLVMPSIIAQGVPCVAVASNEEARVVRASGFTGQLVRVRLASLSELEDGLQYDMEELVGSAEFARQADAIAARHGKTLRIHMALNSSGMSRNGVEMATWSGRGEALQITDQKHLKLVALMTHFAVEDKDDVRKGLAAFNEQTDWLIKHARLDRSKLTLHAANSFATLEVPEARLDMVRTGGALFGDTVPARTEYKRAMQFKSHVAAVHSYPAGNTVGYDRTFTLARDSRLANITVGYSDGYRRVFTNKGHVLINGHRVPVVGKVSMNTLMVDVTDFPDVKGGNEVVLFGKQAGGEITQAEMEEINGALLADLYTVWGNSNPKILVD

SEQ ID NO: 4 - protein, 242 aa, Bacillus subtilis
MRILIANVNTTEAITHAIAEQARAVAAPGTEIVGLTPWFGAESVEGNFESYLAAIAVMDRVLAFEGPYDAVIQAGYGEHGREGLQELLNVPVVDITDAAASTAMYLGHAYSVVTTLDRTVPLIEDRLKLSGLYDRCASVRASGLAVLELEADPLRAVEAIVEQAERAVRDDKAEVICLGCGGMAGLDEQIRQRTGVPVVDGVSAAVTIAESLVRMGLSTSKVRTYATPRAKKVVGWPMRFGR

SEQ ID NO: 5 - DNA, 8405 bp, Yarrowia lipolytica
  source 1..8405: mol_type = other DNA
tcttatttttttcctcatcttctgcctaggttcccaaaatcccagatgcttctctccagtgccaaaagtaagtaccccacaggttttcggccgaaaattccacgtgcagcaacgtcgtgtggggtgttaaaatgtggggggggggaaccaggacaagaggctcttgtgggagccgaatgagagcacaaagcgggcgggtgtgataagggcatttttgcccattttcccttctcctgtctctccgacggtgatggcgttgtgcgtcctctatttctttttatttctttttgttttatttctctgactaccgatttggtttgatttcctcaaccccacacaaataagctcgggccgaggaatatatatatacacggacacagtcgccctgtggacaacacgtcactacctctacgatacacacaagagaccgggttggcggcgcatttgtgtcccaaaaaacagccccaattgccccaattgacccaaattgacccagtagcgggcccaaccccggcgagagcccccttctccccacatatcaaacctcccccggttcccacacttgccgttaagggcgtagggtactgcagtctggaatctacgcttgttcagactttgtactagtttctttgtctggccatccgggtaacccatgccggacgcaaaatagactactgaaaatttttttgctttgtggttgggactttagccaagggtataaaagaccaccgtccccgaattacctttcctcttcttttctctctctccttgtcaactcacacccgaaatcgttaagcatttccttctgagtataagaatcattcaaaagatctgagctcatgaagaagcccgagctgaccgctacatctgtggagaagtttctgatcgagaagttcgactctgtctccgacctcatgcagctctccgaaggtgaggagtcccgagctttctcgttcgacgtgggtggaagaggatacgtccttcgagttaactcgtgtgcagatggattctacaaggatcggtacgtgtaccgacattttgctagcgccgccctgcccattcctgaggtgcttgacatcggtgagttttcggagtcccttacctactgtatctcccggcgagcccagggagttacactccaggacctgcccgagaccgagctgcccgccgtcctccagcccgtggctgaggctatggacgccatcgccgctgctgatctgagccaaacctccggatttggtccttttggccctcagggcattggtcagtacacaacttggcgggatttcatctgcgctatcgccgatcctcacgtttaccactggcaaaccgttatggacgacaccgtgagcgcctctgtcgcccaggctctcgacgagctgatgctttgggctgaggactgtcccgaggtcagacacctggtccacgctgactttggatctaacaacgttctcactgataacggcagaattaccgctgtcatcgactggtctgaggcaatgtttggagattcccagtacgaggtggcaaacatcttcttttggcgaccctggcttgcctgtatggaacagcagacccgatatttcgaacgacgacatcccgagcttgctggttctcctcgactgcgggcttatatgctccgaattggacttgatcaactctaccagtctctggttgacggtaactttgacgacgccgcctgggctcagggacgatgtgacgccattgtccgaagcggagccggtactgtgggccgaacccagatcgcccgacgatctgccgctgtctggaccgatggttgtgttgaggtcctggcagactctggaaacagacgaccttctacccgacccagagccaaagagtaactcggtaggcaattaacagatagtttgccggtgataattctcttaacctcccacactcctttgacataacgatttatgtaacgaaactgaaatttgaccagatattgttgtaaatagaaaatctggcttgtaggtggccacatgcatataggatacattttgttggggagaaccgaacagaggggagaggaggttgcactgagcaatcagaccatgtgaccgttttttgaaggagatgtgctgagagcggggggccagagatcatgtgaggatttgttgagaatcctatggggcctgctagggcaccatccaggctcccgccgccctcccttcggcccgagaaacaagctgtaaaccgctcagatcaagccgcacatatttttgccctccctaccgcctcccacccggaccttcctctgggctgtcttgtatgtttatgtggacgtatggtgtgcggcagctcaattttgattggtcggaaccttaataactttagttgatcaaggtgcgtctaccgtctttgttgcagtccccgcctacgccgcagattaaaggaactaactcaccgcagtggctaacgtagcttttcgctccccgtaacttgtcttctttctcagcacaaacacacatacacaaacagtgagtatagtcaccgtggcgacacaggcacagcgccattgaggcgccgaacgccctctcctccattgaacacacgcacatccacagtggcactctcgactcaattgcacgtggcttgattcacctcaacgcaaattgacacgcaaccgagaggtaccgagtaacaaccgaggtggtggttttgcgatcaatcgggctgcaaacacaggtggcgacattgtcagcctgtgatgtgagacccgacaatggggccattgagggtgcccatcacgggtctcggtaaccagcccatcgcattcatgatgtgtcttgggggggggaggtatcacagggtgtgattgtgttttgcaccaacaaacgcatcaacactatgacacatcggcattcaatggtcgtctcccgtcacaattgagtctatggcgtccttcaactgccacaatcaccgtctggaggtgacgattgtttttttctcagtcgctgtgctgccgcgcgtcttgatgacacccgaaaagcacgtgctgaagcatcataacacgcaacacgtactaacccagtcgacatgacaatgcctcatcgctatatgtttttggcagtctttacacttctggcactaattaatgtggcctcaggagccacagaggcgtgcttaccagcaggccagaggaaaagtgggatgaatataaatttttaccagtattcattgaaagattcctccacgtattctaatgcagcatatatggcttaccaatatgcagacaaagtcaaattgggctctgttagtgggcaaacggatatatctatcaactataatcttccttgtgttacaacctcagggacatatcagtgccctcaagaagatgcatatggtaattggggatgcagaggtaaggggagatgctccaacagtcaagcagtttcatactggagtacagatctgtttggcttttataccactccaacaaacatcaccctagaaatgacaggttactttttaccaccacagacaggttcttacacgttttcttttgcaacaatagatgattctgcaattttatcagtcggtggtagcattgcgttcgaatgttgtgcacaagaacaacctcccatcacatcgactaacttcaccatcaatggtatcaagccatggcatggaagtctccctgataatatcgcagggactgtctacatgtatgctggtttctattatccaatgaagattgtttactcaaatgccgtttcctggggtacacttccaattagtgtgacactaccagatggcactactgttagtgatgactttgaagggtacgtatatacctttgacaacaatctaagccagccaaactgtaccattccagacccttcaaattatactgtcagtactaccataactacaaccgagccatggaccggtactttcacctctacgtctactgagatgactactatcactggcaccaacggtgtaccaactgacgaaaccatcattgttgtcaaaacaccaacaactgctagcaccatcataactacgaccgaagcatggactggcactttcacatctacatccacagaaatgaccaccgtcaccggtaccaacggtttgccaactgatgaaaccattatcgtcatcagaacacctacaacagcaagtactgccataactacaactgagccatggactggcacttttacatctacacccacagaaatgaccaccgtcaccggtaccaacggtttgccaactgatgaaaccattatcgtcatcagaacacctacaactgccaacaccatcataactacaactgagccatggactggcactttcacctctacgtctactgagatgactactgtcactggaaccaacggtgtaccaactgacgaaaccatcattgttgtcaaaacaccaacaactgccaacaccatcataactacaactgagccatggactggcactttcacctctacgtctactgagatgactactatcactggcaccaacggtgtaccaactgacgaaaccatcattgttgtcaaaacaccaacaactgctagcaccataataactacaaccgaaccatggaccggtactttcacatctacatccactgaaatgactactgtcactggaaccaatggcttgccaactgatgaaactgtcattgttgtcaaaactccaactactgccatctcatccagtttgtcatcatcttcaggacaaatcaccagctctatcacgtcttcgcgtccaattattaccccattctatcctagcaatggaacttctgtgatttcttcctcagtaatttcttcctcagacacttcttctctagtcacttcttctctagtcacttcttctctagtcacttcttctctagtcacttcttctccagtcatttcttcttcagtcatttcttcttcagtcatttcttcttcagtcatttcttcctctgtcatttcttcttctacaacaacctccacttctatattctctgaatcatctaaatcatccgtcattccaaccagtagttccacctctggttcttctgagagcgaaactagttcagctagttctgtctcttcttcctcttctatctcttctgaatcaccaaagtctacatattcgtcttcatcattaccacctgttaccagtgcggcaacaagccaggaaactgcttcttcattaccacctgttaccagtgcgacaacaagccaggaaactgcttcttcattaccacctgttaccagtgcgacaacaagccaggaaactgcttcttcattaccacctgttaccagtgtaacaacaagtcaggaaatcacttcatcattaccacctgttaccagtgtaacaacaagtcaggaaataacttcatcattaccacctgttaccagtgcgacaacaagccaggaaactgcttcttcattaccacctgttaccagtgcgacaacaagccaggaaactgcttcttcattaccacctgctaccactacaaaaacgagcgaacaaaccactttggttaccgtgacatcctgcgaatctcatgtgtgcactgaatccatctcctctgcgattgtttccacggccaccgttattgttagcggtgtcacaacagagtataccacatggtgccctatttctaccacagagataacaaagcaaactacggagacaacaaagcaagctttcccatctagtattcaaaaagctttggcaattcctgcaaacaataaaacaggcacaattcaagatgtcgaacacgttattattttaatgcaggaaaaccggtcttttgaccattattttggaacgttaaaaggcgttcgaggttttgctgatcgttttacgattcctctaccgagtggccgccgtgtatgggagcaactcagaagtaacgggcaagctttaacaccttttcatttagatggtacagccaataatgcacagcgagcagatggcacgcctcatacgtggaatgatagtcagttagcatgggacaatgggcgtatggcgaattggccagcccataaaaccgatatatcaatgggctattttaaagaaaaagaaattccatatcagtttgcgcttgcaaatgcctttaccatctgtgatgcctatcattgctctatgcacactggaacagatgcgaaccgttcttatcatttaacgggtacaaatggggcgacaccgaccaagcgttcatttgtaaacaatgaatgggactggattgatggtaatccagccacggcagatcgtggttatacgtggaagacctatgccgagcgtttggaagaagccggtgtaaactggatttgttatcaaaatatgccagatgaatggggcgataatatgcttggtgcattccgctcatttagaaaggcaaatatcgcatctgcttatccggttgcaagtggtggtgaaccgaacaaaccatatgccgacacggggcaaaaattaccgtataaagcttatgatgctgcgactgataatgccaaaaatccattatataagggcattgcaaatactttaccgggcaataaacctgaagaatatctcgacgcttttaaacgagacattcgtgaaggaaaattgccgcaagtctcttggattaatgcaccctcaatttattgtgaacatccagacccttcaagcccagttcaaggggcatggtttattcaagaaattattgatgcattaactgctgtgccagaggtttggagtaaaacagcactgattatcaattttgatgaaaatgatggctattttgaccacgtaccatcaccatctgcgccatctcgacttaaaaatggtcaatacgcagggaaatcaacattaagcagtgccgacatgcaggatgaatattttgatcatgctgcaccagagggaagccattctcagcctacacctgatgggcgcgtttatgggccagggcctcgtgttccattatatgtgatttctccatggagccgtggtggttgggtcaactcgcaagtttttgaccatacgtccgtgcttatgtttttagaaaaacgatttggtataaaagagccaaatattagtccataccgccgtgcggtgtgtggtgatttaaccagtgcatttaattttaaaacaccaaatgcagatgttctaccacagctcaatggaaagcaaacacgtttacaagcagatgagttaagagaaaatcaagaagctttacctgctgttccagtaccaacagatagcaagttaccgattcagcaaagtggtatacgtctgtcaagagcattgccttatgagttgcataccagtgcgcgttgtaaagcggatggaaaggtgcaattgattttctctaatacaggtcagcaagcggcggtttttcatgtatatgacaagctcaatctagaccgtattccaaagcgttatattgtagagccgaataaaaccttagatgatgaatgggatgctttaaaagataacttaggtcgctatgatttatgggtgttaggcccaaatggctaccatcgtcattttaaaggagatactcaacgtattgtcgatagtggaattaaacctgaaattcgagtgtgttatgacattgctaatggtgatgtctatgtagagcttatgaatgacgggactaaggatgcaatattaacggtaaaaccgtgtgcatatcgacaagacgcaccgttacaacttgccgtaaaagcgggacaggttgttaagcaacattgggctttggctgatataggccattggtatgattttgaaatcacatgccaaagtgatgtgtcttattaccgacgctttgctggtcgggttgaaacgggtgaggactcttttagtgatcctgcgatgatctaactcggtaggcaattaacagatagtttgccggtgataattctcttaacctcccacactcctttgacataacgatttatgtaacgaaactgaaatttgaccagatattgttgtaaatagaaaatctggcttgtaggtggcgttaaccagcagaaccctgctcagaacccccgacctccttactatgagagcactcttcgacctttcctgttccgagaggatgaggatgacgacatttgcgagctggacgaggaatagatggagcgtgtgttctgagtcgatgttttctatggagttgtgagtgttagtagacatgatgggtttatatatgatgaatgaatagatgtgattttgatttgcacgatggaattgagaactttgtaaacgtacatgggaatgtatgaatgtgggggttttgtgactggataactgacggtcagtggacgccgttgttcaaatatccaagagatgcgagaaactttgggtcaagtgaacatgtcctctctgttcaagtaaaccatcaactatgggtagtatatttagtaaggacaagagttgag

(19) United States
(12) Patent Application Publication
(10) Pub. No.: US 2025/0277174 A1
(43) Pub. Date: Sep. 4, 2025

(54) COMPOSITE BLACK TEA FERMENTATION LIQUOR CONTAINING CERAMIDE AND D-AMINO ACID

(71) Applicants: GUANGZHOU ZHONGZHUANG BEAUTY COSMETICS CO., LTD., GUANGZHOU (CN); ZHEJIANG ACADEMY OF AGRICULTURAL SCIENCES, HANGZHOU (CN); HANGZHOU JIAJIALE BIOTECHNOLOGY CO., LTD, HANGZHOU (CN)

(72) Inventors: WEIHUA PENG, GUANGZHOU (CN); ZETING HUANG, GUANGZHOU (CN); JIE XUAN, GUANGZHOU (CN); SONG JIAO, HANGZHOU (CN); SHANSHAN DI, HANGZHOU (CN); XINQUAN WANG, HANGZHOU (CN); SHUNZHE JI, HANGZHOU (CN)

(21) Appl. No.: 18/671,959

(22) Filed: May 22, 2024

(30) Foreign Application Priority Data
Mar. 1, 2024 (CN) 202410234356.5

(51) Int. Cl. C12G 3/026

(52) U.S. Cl. CPC C12G 3/026

(57) ABSTRACT

Provided is a composite black tea fermentation liquor containing ceramide and D-amino acid. The composite black tea fermentation liquor is prepared by a preparation method including steps as follows. S1, a strain producing ceramide is constructed. S2, a strain producing D-amino acid is constructed. S3, a seed liquid of the strain producing ceramide is cultured. S4, a seed liquid of the strain producing D-amino acid is cultured. S5, a black tea extracting solution is prepared. S6, the seed liquids prepared in step S3 and step S4 are centrifuged and re-suspended, and then added into the black tea extracting solution prepared in step S5 for fermentation. S7, the obtained black tea fermentation liquor is separated to obtain a final composite black tea fermentation liquor.

### TECHNICAL FIELD

The present disclosure relates to the technical field of black tea fermentation, in particular to a composite black tea fermentation liquor having an anti-aging effect which contains ceramide and D-amino acid, and a preparation method thereof.

### SEQUENCE LISTING

The instant application contains a Sequence Listing which has been submitted electronically in ST.26 format and is hereby incorporated by reference in its entirety. Said ST.26 copy, created on May 16, 2024, is named Sequence Listing.xml and is about 15,324 bytes in size.

### BACKGROUND

Black tea is a fully fermented tea which is made from fresh tea leaves undergoing deep fermentation. Antioxidant active ingredients in the black tea mainly include theaflavin, thearubigins and theabrownin. The thearubigins is the main component of the red substance in the black tea soup, and an astringency and an irritation of the thearubigins are weaker than those of the theaflavin. The theabrownin contains a combination of amino acids, saccharides and the like. There are some catechin substances in the black tea. The above substances are mainly used to remove free radicals by directly removing oxygen radicals, blocking lipid peroxidation, complexing metal ions, inhibiting activity of oxidase, activating antioxidant enzyme activity and the like, so that effects of resisting oxidation, slowing skin aging, improving skin luster and the like are achieved.

Ceramide is a kind of amide compounds formed by dehydrating long chain fatty acids and amino groups of sphingosine. Natural ceramides are commonly found in yeast, plants and some mammalian tissues. The phytosphingosine is a precursor of ceramide. The phytosphingosine can help generation of ceramide, and can help the skin itself to produce various required ceramides fundamentally. An intercellular lipid (ceramide 50%) is made up of the phytosphingosine together with cholesterol (25%) and free fatty acid (15%), and it is configured to participate in a function for maintaining skin barrier. 40%-50% of sebum in the human stratum corneum is made up of the ceramide, and the ceramide plays an important role in maintaining balance of water in the stratum corneum. The ceramide has strong ability to associate water molecules, and the ceramide maintains water in the skin by forming a mesh structure in the stratum corneum. As the age grows, the ceramide in the body gradually decreases, the skin becomes dark and dry in lack of water. Supplementation of ceramide can also reduce fine lines and signs of aging.

In the efficacy components of the black tea, theanine, tea polyphenol and theaflavin have been widely reported. In recent years, D-amino acids have gradually been concerned. For example, D-cysteine in the black tea can be used as an antioxidant and has effects of diminishing inflammation and resisting oxidation. D-alanine can promote epidermal keratinocytes to produce adhesion protein 332, and maintains homeostasis of the skin. D-glutamic acid has an effect of protecting the skin barrier and promoting a function of the skin barrier to recovery.

Therefore, in a fermentation process of the black tea, production of ceramide and D-amino acids will improve the efficacy of the black tea, so that the black tea fermentation liquor has great market potential and additional value in cosmetics. In addition, in the fermentation process of the black tea, components such as polypeptide, biological surfactant and the like can also be generated, which also improve the value of the black tea.

### SUMMARY

In view of the above problems in the related art, the present disclosure provides a composite black tea fermentation liquor having an anti-aging effect, which contains ceramide and D-amino acid. In a preparation process of the composite black tea fermentation liquor, ceramide and D-amino acid can be generated, so that the effect of the black tea fermentation liquor is improved, and the market value thereof is improved.

The technical solution of the present disclosure is provided as follows:

A composite black tea fermentation liquor, which contains ceramide and D-amino acid and has an anti-aging effect, is provided, which is prepared by a preparation method including steps as follows:
S1, constructing a strain producing ceramide;
S2, constructing a strain producing D-amino acid;
S3, culturing a seed liquid of the strain producing ceramide;
S4, culturing a seed liquid of the strain producing D-amino acid;
S5, preparing a black tea extracting solution;
S6, centrifuging and re-suspending the seed liquid prepared in step S3 and the seed liquid prepared in step S4, and then adding them into the black tea extracting solution prepared in step S5 for fermentation; and
S7, separating an obtained black tea fermentation liquor to obtain a final composite black tea fermentation liquor.

In some embodiments, the strain producing ceramide in step S1 is obtained by expressing, through a surface display method, a phospholipase in Yarrowia lipolytica, and an amino acid sequence of the phospholipase is as shown in SEQ ID No. 1.

In some embodiments, the strain producing D-amino acid in step S2 is obtained by expressing a glutamate racemase, an alanine racemase and an aspartate racemase in Bacillus subtilis, an amino acid sequence of the glutamate racemase is as shown in SEQ ID No. 2, an amino acid sequence of the alanine racemase is as shown in SEQ ID No. 3, and an amino acid sequence of the aspartate racemase is as shown in SEQ ID No. 4.

In some embodiments, the glutamate racemase, the alanine racemase and the aspartate racemase are expressed by plasmid, or integrated into genome expression.

In some embodiments, the culturing the seed liquid of the strain producing ceramide in step S3 includes: transferring the strain producing ceramide prepared in step S1 into a seed culture medium, and performing shaking culture for 12 h-72 h at a temperature of 25° C.-37° C.

A formula of the seed culture medium includes glucose at 20 g/L, yeast extract at 10 g/L, peptone 20 g/L, and natural pH.

In some embodiments, the culturing the seed liquid of the strain producing D-amino acid in step S4 includes: transferring the strain producing D-amino acid prepared in step S2 into a LB medium, and performing shaking culture for 12 h-72 h at a temperature of 25° C.-37° C.

A formula of the LB culture medium includes yeast extract at 5 g/L, peptone at 10 g/L, sodium chloride at 10 g/L, and natural pH.

In some embodiments, the preparing the black tea extracting solution in step S5 includes: grinding black tea into powder, and adding purified water; decocting with slow fire for 10 min-240 min at a temperature of 50° C.-100° C., then performing centrifugation and filtering, and collecting a filtrated liquid.

In some embodiments, in step S5, a mass ratio of the black tea to the purified water is 1:15-25, and preferably 1:20.

In some embodiments, in step S5, the decocting is performed at a temperature of 70° C. for 30 min.

In some embodiments, in step S5, the black tea extracting solution is filtered and sterilized using a filter membrane with a pore size of 0.22 μm.

In some embodiments, the fermentation in step S6 includes:
M1: firstly, inoculating the re-suspended seed liquid of the strain producing ceramide into the black tea extracting solution according to an inoculation amount of 0.1%-20%, adding sterilized glucose at 1 g/L-50 g/L, and culturing for 2 h-12 h at a temperature of 15° C.-37° C.;
M2: then, inoculating the re-suspended seed liquid of the strain producing D-amino acid according to an inoculation amount of 0.1%-10%, and continuously culturing for 2 h-12 h at a temperature of 15° C.-40° C.;
M3: subsequently, adding sphingomyelin at 1 g/L-10 g/L and galactose at 1 g/L-20 g/L, and continuously culturing for 2 h-12 h at the temperature of 15° C.-37° C.; and
M4: finally, increasing the temperature to 40° C.-45° C. and continuously culturing for 1 h-2 h.

In some embodiments, in step S6, the centrifuging and re-suspending the seed liquids includes: separately centrifuging the seed liquid of the strain producing ceramide and the seed liquid of the strain producing D-amino acid, then washing with purified water for 3 times, and thereafter, re-suspending with purified water.

In some embodiments, the separating the black tea fermentation liquor in step S7 includes: crushing thalli of the black tea fermentation liquor with a high pressure homogenizer, and then performing centrifugation to obtain a supernatant; filtering and sterilizing the supernatant with a ceramic membrane or a filter membrane with a pore size of 0.22 μm or 0.45 μm, to obtain the final composite black tea fermentation liquor.

In some embodiments, the crushing is performed 2-4 times at a pressure of 1000 bar, and the centrifugation is performed for at least 10 min at a centrifugal force of more than 5000 g.

In the present disclosure, the following technical effects can be brought about:
1. In the present disclosure, a strain capable of producing ceramide is constructed, which can increase the content of the ceramide in the black tea fermentation liquor; in addition, a strain capable of producing D-amino acid is constructed, which can increase the content of the D-amino acid in the black tea fermentation liquor.
2. In the composite black tea fermentation liquor prepared by the method of the present disclosure, the contents of the ceramide and the D-amino acid are all remarkably increased; as such, when the obtained composite black tea fermentation liquor is used in cosmetics, performance of antioxidant resistance, skin repair and skin barrier can be improved. Furthermore, substances such as polypeptide, surface active agent and fruit acid can also be generated in the fermentation process, and multiple activities are realized.
3. The preparation method of the present disclosure not only can generate multiple active components such as polypeptide, surface active agent, and fruit acid, but also can generate the ceramide and various D-amino acids, these active components have significant advantages in improving the performance of oxidation resistance, skin repair, skin barrier, skin ecological balance reconstruction and the like of the black tea fermentation liquor, thereby improving the efficacy and value of the black tea fermentation liquor.

### BRIEF DESCRIPTION OF THE DRAWINGS

FIG. 1 is a profile of plasmid pJJL-23-032-3.

FIG. 2 is a diagram illustrating performance evaluation of ceramide JJL-23-032-1.

FIG. 3 illustrates comparison of catalytic results of JJL-23-032-2 for different amino acids.

### DETAILED DESCRIPTION OF PREFERRED EMBODIMENTS

The present disclosure will be described in detail below with reference to the accompanying drawings and the examples of the present disclosure. Apparently, the described examples are only some of the examples of the present disclosure, but not all of the examples. Based on the examples in the present disclosure, all other examples obtained by those skilled in the art without inventive work fall within the protection scope of the present disclosure.

The strains used in the following examples are commercially available.

### Example 1: Construction of a Strain Producing Ceramide

In order to achieve the surface display of the phospholipase in Yarrowia lipolytica, pox3U-P1-hph-T-P2-Flo1P::PLC-T-pox3D driven by a constitutive promoter of the Yarrowia lipolytica was synthesized. Pox3U was an upstream homologous arm in a homologous recombination construction, and pox3D was a downstream homologous arm in the homologous recombination construction. P1 is an endogenous constitutive promoter of Yarrowia lipolytica and is configured to express hygromycin resistance gene hph.

In order to realize the surface display of the phospholipase PLC as illustrated in SEQ ID No. 1, Flo1P was fused at its n-terminal, and an expression was driven by using an endogenous constitutive promoter P2 of Yarrowia lipolytica. T was the terminator. A DNA sequence of the expression cassette is as illustrated in SEQ ID No. 5.

In order to achieve the construction of pox3U-P1-hph-T-P2-Flo1P::PLC-T-pox3D, pox3U and pox3D were first integrated onto the plasmid pUC18. Pox3U was obtained by taking Yarrowia lipolytica genome DNA as a template, and amplifying with a primer P1/P2. Pox3D was obtained by taking Yarrowia lipolytica genome DNA as a template, and amplifying with a primer P3/P4. Plasmid pUC18 was double-cleaved by BamHI and EcoRI. After being purified separately, the three fragments were connected by Gibson and converted into E. coli DH5α, and were screened by using an LB plate containing ampicillin at 50 μg/mL. The obtained positive clones were subjected to sequencing verification. The validated plasmid was named as pJJL-23-032-1.

P1:
GCTATGACCATGATTACGAATTCtcttatttttttcctcatcttctg
P2:
gctggttaactgtgtgtatcgtagaggtagtg
P3:
gatacacacagttaaccagcagaaccctgc
P4:
CTGCAGGTCGACTCTAGAGGATCCctcaactcttgtccttacta

P1-hph-T-P2-FloyP::PLC-T was synthesized by HUADA gene and amplified by P5/P6. Taking pJJL-23-032-1 as a template, a skeleton template was obtained by amplifying with a primer P7/P8. After being purified separately, the two fragments were connected by Gibson and converted into E. coli DH5α, and were screened by using an LB plate containing ampicillin at 50 μg/mL. The obtained positive clones were subjected to sequencing verification. The validated plasmid was named as pJJL-23-032-2.

The culture medium for the LB plate was composed by yeast powder at 5 g/L, peptone at 10 g/L, sodium chloride at 10 g/L, and agar at 15 g/L.

P5:
ctacctctacgatacacacaagagaccgggttggcggcgc
P6:
gcagggttctgctggttaacGCCACCTACAAGCCAGATTTTC
P7:
tgtgtgtatcgtagaggtag
P8:
gttaaccagcagaaccctgc

pJJL-23-032-2 was double-cleaved by BamHI and EcoRI to obtain a recombinant expression frame fragment. The recombinant expression frame fragment was transferred into Yarrowia lipolytica by homologous recombination using a yeast transformation kit (Frozen-EZ Yeast Transformation II), and was coated on a YPD flat plate culture medium containing hygromycin at 400 μg/mL for primary screening. It was cultured for 48 h at 28° C., and a single colony was thereby grown.

Then, the single colony was picked into YPD liquid culture medium containing hygromycin, cultured for 48 h at 28° C., and genome was extracted therefrom. It was then verified by PCR verification performed with a primer P9/P10, and a correct strain was selected and named as JJL-23-032-1.

The YPD flat plate culture medium was composed by yeast powder at 10 g/L, peptone at 20 g/L, glucose at 20 g/L, and agar at 20 g/L. The YPD liquid culture medium was composed by yeast powder at 10 g/L, peptone at 20 g/L and glucose at 20 g/L.

P9:
acacccgcccgctttgtgctctc
P10:
ctcaccgatgtcaagcacctc

### Example 2: Construction of a Strain Producing D-Amino Acid

In order to realize the production of D-amino acids, coding gene of glutamate racemase, coding gene of alanine racemase and coding gene of aspartate racemase were expressed in Bacillus subtilis, and the specific construction process is as follows.

Taking a Pseudomonas putida KT2440 genome as a template, a glutamate racemase gene as illustrated in SEQ ID No. 2 was amplified with a primer P11/P12, an alanine racemase gene as illustrated in SEQ ID No. 3 was amplified with a primer P13/P14, and an aspartate racemase gene as illustrated in SEQ ID No. 4 was amplified with a primer P15/P16. Taking pH08 plasmid as a template, a plasmid backbone was obtained by amplifying the template with a primer P17/P18.

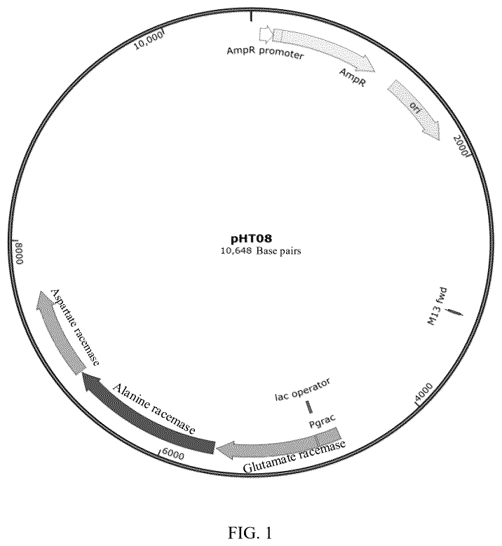

The obtained four fragments were purified separately, and then they were connected by Gibson and converted into E. coli DH5α. Screening was performed by using an LB plate culture medium containing ampicillin at 50 μg/mL. The obtained positive clones were subjected to sequencing verification. The validated plasmid was named as pJJL-23-032-3. A plasmid profile is illustrated in FIG. 1.

P11:
CAATTAAAGGAGGAAGGATCTATGGCTGAGCGCTCGGCGCC
P12:
GGGCATAGATCCTTCCTCCTTTTCACAACGCAAAGCTTTGCAC
P13:
GTGAAAAGGAGGAAGGATCTATGCCCTTTCGCCGTACCCT
P14:
TACGCATAGATCCTTCCTCCTTTTCAGTCGACGAGTATCTTCG
P15:
CTGAAAAGGAGGAAGGATCTATGCGTATTCTGATCGCCAAC
P16:
CCAGGTAAGGTATAAACTTTTCAGCGGCCGAAGCGCATC
P17:
AGATCCTTCCTCCTTTAATTG

PJJL-23-032-3 was transferred into Bacillus subtilis, and screened by a LB plate culture medium containing chloramphenicol at 5 μg/mL. The obtained positive clones were subjected to PCR verification with a primer P19/P20. The validated strain was named as JJL-23-032-2.

P19:
GGCTTGAACAATCACGAAAC
P20:
GTCGGACTTATGCCACAGCAC

### Example 3: Determination of Content of the Ceramide

10 mL to-be-tested sample was taken, and 40 mL chloroform/methanol (at a volume ratio of 2:1) was added thereto for extraction. The sample was centrifuged and layered after vigorous shaking. The upper aqueous phase containing proteins, nucleic acids and water-soluble lipids was discarded, and the lower-layer organic phase was collected as a lipid crude extract containing ceramide. After the obtained crude extract was dried, 10 mL chloroform/methanol (at a volume ratio of 2:1) and 1 mL water were added, and they were vigorously shaken for centrifugal stratification. The lower organic phase was dried and then solved in chloroform for HPLC analysis.

The liquid chromatograph was LC-16 manufactured by Shimadzu Corporation of Japan, and the detector was an evaporative light scattering detector. A temperature of the detector temperature was set to 40° C., and air pressure was set to 350000 Pa. The chromatography column was an Allima CN column (4.6×150 mm). The mobile phase was n-hexane/ethanol (at a volume ratio of 99:1) at a volume rate of flow of 0.8 mL/min.

### Example 4: Determination of Content of D-Amino Acid

200 μL to-be-tested sample was taken, and 4.8 mL L-sulfoalanine at 0.1 mM was added; and after mixing uniformly, 0.5 mL of the mixture was taken, and o-phthalaldehyde and N-acetylcysteine were added thereto for derivatization of amino acids. The sample was analyzed using LC-16 High Performance Liquid Chromatography produced by Shimadzu Corporation of Japan, and the chromatography column was a ODS-M80 chromatography column (4.6×150 mm) produced by J′sphere. The mobile phase was a 50 mM sodium acetate solution (pH 5.55) containing 3.8% methanol, at a flow rate of 1 mL/min. The detector was a fluorescence detector, the excitation wavelength was 320 nm, and the absorption wavelength was 440 nm.

### Example 5: Production of a Ceramide by JJL-23-032-1 Strain

Single colony of the JJL-23-032-1 strain was selected and transferred to a 5 mL YPD liquid medium, and was subjected to shaking culture performed at 30° C. and 200 rpm for 48 h. Then, the all were transferred to a 500 mL un-baffled shake flask containing 100 mL YPD liquid medium. After been cultured under vigorous shaking at 200 rpm and 30° for 24 h, lecithin at 5 g/L was added, the shaking culture was continued at 30° C. and 200 rpm for 48 h. Then, it was cultured for 1 h with the temperature increased to 40° C. After the culture was finished, crushing was carried out three times using a high-pressure homogenizer at a pressure of 1000 bar. The supernatant was centrifuged to determine the content of the ceramide.

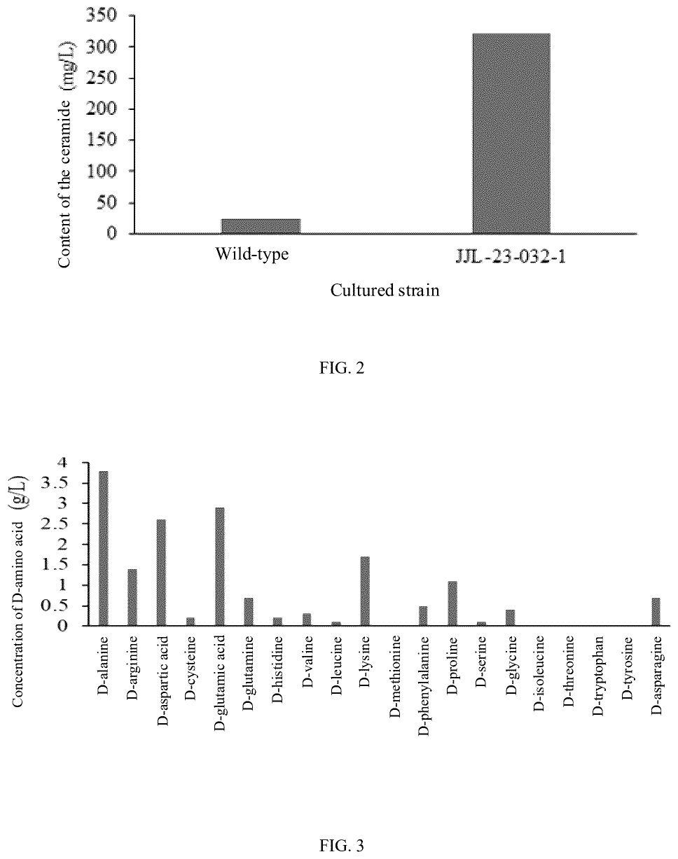

As a control, wild-type Yarrowia lipolytica was picked and subjected to the same culture and separation operations, to determine the content of the ceramide. The determination results are illustrated in FIG. 2. It can be see that the ceramide at 24 mg/L may be obtained by using the wild-type Yarrowia lipolytica, whereas the ceramide at 322 mg/L may be obtained by using JJL-23-032-1. The content of ceramide was increased by 12.4 times.

### Example 6: Production of D-Amino Acid with JJL-23-032-2 Strain

Single colony of JJL-23-032-2 was selected and inoculated into 5 mL LB liquid medium, and was subjected to shaking culture performed at 37° C. and 200 rpm for 12 h. Then, the all was transferred to a 500 mL baffled shake flask containing 100 mL fermentation medium. After been subjected to the shaking culture performed at 30° C. and 200 rpm for 12 h, 10 g/L galactose was added, and further shaking culture was performed at 30° C. and 200 rpm for 36 h. The fermentation medium was composed by sucrose at 70 g/L, yeast powder at 1 g/L, NaNO₃ at 25 g/L, KH₂PO₄ at 0.333 g/L, Na₂HPO₄·12H₂O at 1 g/L, MgSO₄·7H₂O at 0.15 g/L, CaCl₂) at 7.5 mg/L, MnSO₄·H₂O at 6 mg/L, FeSO₄·7H₂O at 6 mg/L, and PH at 7.0.

The culture solution was collected and centrifuged, and thallus precipitate was collected. The resulting thallus precipitate was washed three times with 100 mM PB, and finally re-suspended in 100 mL 100 mM PB (pH 8.0). And the capability of the cultured thalli for producing different D-amino acids was measured respectively. The determination method is as follows:

50 mL BD tubes were taken, 3 mL re-suspended thalli was added into each of them, and then L-alanine, L-arginine, L-aspartic acid, L-cysteine, L-glutamic acid, L-glutamine, L-histidine, L-valine, L-leucine, L-lysine, L-methionine, L-phenylalanine, L-proline, L-serine, L-glycine, L-isoleucine, L-threonine, L-tryptophan, L-tyrosine and L-asparagine each at a concentration of 10 g/L were added respectively into the tubes, and then the shaking culture was performed for 6 h at 30° C. and 200 rpm. The contents of D-amino acids obtained by the cultured thalli converting different kinds of L-amino acids are illustrated in FIG. 3. As can be seen from FIG. 3, the cultured strain can catalyze the production of most of the D-amino acids, with the highest catalytic activity for alanine, but no D-methionine, D-isoleucine, D-threonine, D-tryptophan and D-tyrosine were obtained.

### Example 7: Preparation of Composite Black Tea Fermentation Liquor

(1) JJL-23-032-1 strain activation: single colony of the JJL-23-032-1 strain was selected and inoculated into a 5 mL YPD liquid medium (i.e., seed culture medium), and was subjected to shaking culture performed at 30° C. and 200 rpm for 48 h. The YPD liquid medium was composed by yeast extract at 5 g/L, peptone at 10 g/L, glucose at 20 g/L, and natural pH.
(2) JJL-23-032-2 strain activation: single colony of the JJL-23-032-2 strain was selected and inoculated into a 5 mL LB culture medium, and was subjected to shaking culture performed at 37° C. and 200 rpm for 12 h. The LB culture medium was composed by yeast extract at 5 g/L, peptone at 10 g/L, sodium chloride at 10 g/L, and natural pH.
(3) Preparation of the black tea extracting solution: the black tea was grinded into powder, and purified water was added. It was decocted with slow fire for 30 min at a temperature of 70° C., and centrifuged, and a filtrated liquid was collected. The black tea extracting liquid was filtered and sterilized by using a filter membrane with a pore size of 0.22 μm.
(4) Black tea fermentation: after each of the JJL-23-032-1 seed liquid and the JJL-23-032-2 seed liquid prepared respectively in steps (1) and (2) was centrifuged, it was washed with purified water for 3 times, and then re-suspended with purified water. The re-suspended JJL-23-032-1 was inoculated into the black tea extracting solution according to an inoculation amount of 5%, sterilized glucose at 10 g/L was added, and it was then cultured for 6 h at 30° C. Then, the re-suspended JJL-23-032-2 seed liquids was added according to an inoculation amount of 5%, and continuously cultured for 6 h at 30° C. Subsequently, sphingomyelin at 5 g/L and galactose at 10 g/L were added, and continuously cultured for 6 h at 30° C. Then, the temperature was increased to 40° C., and it was continuously cultured for 1 h.
(5) After the fermentation was finished, the thalli in the fermentation liquor was crushed by using a high-pressure homogenizer. The pressure for the crushing was 1000 bar, and the crushing was repeated 3 times. The liquor obtained after the crushing was centrifuged to separate fragments of the thalli, and the centrifugation was performed for 10 min at a centrifugal force of 10000 g.
(6) The supernatant was obtained, and the black tea fermentation liquor was further filtered and sterilized by using a filter membrane with a pore size of 0.22 μm, to obtain the composite black tea fermentation liquor.
(7) The contents of the ceramide and various D-amino acids in the composite black tea fermentation liquor obtained in step (6) and the black tea extracting solution obtained in step (3) were determined respectively, and the results are illustrated in Table 1.

TABLE 1
comparison of contents of ceramide and D-amino
acids between composite black tea fermentation
liquor and black tea extracting solution.

| | |
|---|---|
| Composite black tea | Black tea extracting |
| fermentation liquor | solution |

| | | | |
|---|---|---|---|
| Ceramide | 184 | mg/L | Not detected |
| D-alanine | 0.250 | ppm | 0.056 ppm |
| D-arginine | 0.041 | ppm | 0.006 ppm |
| D-aspartic acid | 2.418 | ppm | 1.285 ppm |
| D-cysteine | 0.252 | ppm | 0.012 ppm |
| D-glutamic acid | 3.363 | ppm | 1.124 ppm |
| D-glutamine | 0.112 | ppm | 0.018 ppm |
| D-histidine | 1.862 | ppm | 0.252 ppm |
| D-valine | 0.089 | ppm | Not detected |
| D-leucine | 0.673 | ppm | 0.115 ppm |
| D-lysine | 0.133 | ppm | 0.056 ppm |
| D-phenylalanine | 0.112 | ppm | 0.017 ppm |
| D-proline | 0.733 | ppm | 0.058 ppm |
| D-serine | 0.173 | ppm | 0.057 ppm |
| D-glycine | 4.313 | ppm | 1.084 ppm |
| D-asparagine | 0.476 | ppm | 0.260 ppm |

As can be seen from the table, the concentration of the ceramide in the composite black tea fermentation liquor was 184 mg/L, the contents of various D-amino acids were increased at different levels, and the content of glutamic acid was the highest, which was 3.363 ppm. The total content of D-amino acids in the composite black tea fermentation liquor was 15 ppm, which is 2.4 times higher than that of the black tea extracting solution.

### Example 8: Determination of Anti-Wrinkle Index of Fibroblasts of the Composite Black Tea Fermentation Liquor and the Black Tea Extracting Solution

The anti-wrinkle index was determined by referring to a group standard T/SHRH031-2020 Cosmetic Tightness and Anti-Wrinkle Efficacy Test-Determination of Content of In vitro Fibroblast Type I Collagen. Human dermal fibroblasts were digested with trypsin/EDTA at a digestion concentration of 0.25%; a T75 culture bottle was used, and a dosage was 3 mL. It was observed under an inverted microscope that, when most of the cells were rounded and in a suspended state, a serum-containing DMEM medium having a volume about 3 times the volume of trypsin and was added to terminate the digestion, which was then collected into a centrifuge tube to centrifuge and centrifuged for 6 min at 800 r/min. After the centrifugation was finished, the supernatant was discarded, and a certain volume of cell culture medium was added into the centrifuge tube. The cells were mixed uniformly by blowing through an elbow pipette, and counted by a cell counter or blood cell counting board. The cells were diluted with a cell culture medium to a density of 2.5×106, and inoculated into a 96-well plate with 200 μL of fluid per well. After inoculation, the cell culture medium is placed in a CO₂ incubator to culture for 24 h.

The culture medium was discarded, a culture medium containing the black tea extracting solution of 20% and a culture medium containing the black tea fermentation liquor of 20% were added respectively for two groups, and a normal cell culture medium was added into the blank group, in which 200 μL was added per well. Thereafter, the 96-well plate was placed in a CO₂ incubator to culture for 24 h. The supernatant of the cell culture was centrifuged at 4° C. and a centrifugal force of 1000 g for 15 min. The supernatant was taken into a 1.5 mL sterile centrifuge tube, and placed in an ultralow temperature −80° C. refrigerator for cryopreservation. ELISA detection was performed based on instructions of human type I collagenase linked immunosorbent assay kit.

After determination, the collagen content of cells treated by the composite black tea fermentation liquor was 8.5±0.4 ng/mL, the collagen content of cells treated by the black tea extracting solution was 7.2±0.3 ng/mL, and the collagen content of the blank group cell was 5.3±0.3 ng/mL. The results shew that the composite black tea fermentation liquor can significantly improve the collagen content in fibroblasts.

Although the examples of the present disclosure have been disclosed in the above, they are not limited to the applications listed in the specification and the examples, and they are applicable to a variety of fields suitable for the present disclosure. For those skilled in the art, several changes, modifications, substitutions or variations may also be made to these examples without departing from the principle and spirit of the present disclosure. Therefore, the present disclosure is not limited to specific details without departing from the general concepts defined by the claims and their equivalents.

What is claimed is:

1. A composite black tea fermentation liquor, containing ceramide and D-amino acid, wherein the composite black tea fermentation liquor is prepared by a preparation method comprising steps of:
S1, constructing a strain producing ceramide;
S2, constructing a strain producing D-amino acid;
S3, culturing a seed liquid of the strain producing ceramide;
S4, culturing a seed liquid of the strain producing D-amino acid;
S5, preparing a black tea extracting solution;
S6, centrifuging and re-suspending the seed liquid prepared in step S3 and the seed liquid prepared in step S4, and then adding them to the black tea extracting solution prepared in step S5 for fermentation; and
S7, separating an obtained black tea fermentation liquor to obtain a final composite black tea fermentation liquor.

2. The composite black tea fermentation liquor of claim 1, wherein the strain producing ceramide in step S1 is obtained by expressing, through a surface display method, a phospholipase in wild-type Yarrowia lipolytica, and an amino acid sequence of the phospholipase is as shown in SEQ ID No. 1.

3. The composite black tea fermentation liquor of claim 1, wherein the strain producing D-amino acid in step S2 is obtained by expressing a glutamate racemase, an alanine racemase and an aspartate racemase in Bacillus subtilis, an amino acid sequence of the glutamate racemase is as shown in SEQ ID No. 2, an amino acid sequence of the alanine racemase is as shown in SEQ ID No. 3, and an amino acid sequence of the aspartate racemase is as shown in SEQ ID No. 4.

4. The composite black tea fermentation liquor of claim 3, wherein the glutamate racemase, the alanine racemase and the aspartate racemase are expressed by plasmid, or integrated into genome expression.

5. The composite black tea fermentation liquor of claim 1, wherein the culturing the seed liquid of the strain producing ceramide in step S3 comprises:
transferring the strain producing ceramide prepared in step S1 into a seed culture medium, and performing shaking culture for 12 h-72 h at a temperature of 25° C.-37° C.;
wherein a formula of the seed culture medium comprises: glucose at 20 g/L, yeast extract at 10 g/L of, peptone at 20 g/L, and natural pH.

6. The composite black tea fermentation liquor of claim 1, wherein the culturing the seed liquid of the strain producing D-amino acid in step S4 comprises:
transferring the strain producing D-amino acid prepared in step S2 into a LB culture medium, and performing shaking culture for 12 h-72 h at a temperature of 25° C.-37° C.;
wherein a formula of the LB culture medium comprises yeast extract at 5 g/L of, peptone at 10 g/L, sodium chloride at 10 g/L, and natural pH.

7. The composite black tea fermentation liquor of claim 1, wherein the preparing the black tea extracting solution in step S5 comprises:
grinding black tea into powder, and adding purified water; decocting with slow fire for 10 min-240 min at a temperature of 50° C.-100° C., then performing centrifugation and filtering, and collecting a filtrated liquid.

8. The composite black tea fermentation liquor of claim 1, wherein the fermentation in step S6 comprises:
M1: firstly, inoculating the re-suspended seed liquid of the strain producing ceramide into the black tea extracting solution according to an inoculation amount of 0.1%-20%, adding sterilized glucose at 1 g/L-50 g/L, and culturing for 2 h-12 h at a temperature of 15° C.-37° C.;
M2: then, inoculating the re-suspended seed liquid of the strain producing D-amino acid according to an inoculation amount of 0.1%-10%, and continuously culturing for 2 h-12 h at a temperature of 15° C.-40° C.;
M3: subsequently, adding sphingomyelin at 1 g/L-10 g/L and galactose at 1 g/L-20 g/L, and continuously culturing for 2 h-12 h at a temperature of 15° C.-37° C.; and
M4: finally, increasing the temperature to 40° C.-45° C., and continuously culturing for 1 h-2 h.

9. The composite black tea fermentation liquor of claim 1, wherein the separating the black tea fermentation liquor in step S7 comprises: crushing thalli of the black tea fermentation liquor with a high pressure homogenizer, and then performing centrifugation to obtain a supernatant; filtering and sterilizing the supernatant using a ceramic membrane or a filter membrane with a pore size of 0.22 μm or 0.45 μm, to obtain the final composite black tea fermentation liquor.

10. The composite black tea fermentation liquor of claim 9, wherein the crushing is performed 2-4 times at a pressure of 1000 bar, and the centrifugation is performed for at least 10 min at a centrifugal force of more than 5000 g.
